(19) United States
(12) Patent Application Publication
(10) Pub. No.: US 2008/0310179 A1
(43) Pub. Date: Dec. 18, 2008

(54) Hinged Light Bar

(76) Inventor: Roy Bates, Gibsonton, FL (US)

Correspondence Address: PLAGER LAW OFFICES, 16152 BEACG BLVD., SUITE 207, HUNTINGTON BEACH, CA, 92647, US

(21) Appl. No.: 11/764,345

(22) Filed: Jun. 18, 2007

(51) Int. Cl. B60Q 1/00

(52) U.S. Cl. 362/506; 362/485; 362/549

(57) ABSTRACT

A hinged light bar comprising a hinged bar having a top, bottom, side and rear, and adapted to receive one or more mud flaps; and said bar being removably securable to a vehicle. The hinged light bar: further adapted to receive one or more lights operatively engaging said vehicle; further comprising one or more lock members on a top, bottom, side, or rear of said bar for securing the hinged bar in either an extended or folded position; further comprising one or more flanges extending from the hinged bar and adapted to receive one or more mud flaps; further comprising a first and a second hinged side of said hinged bar wherein said first hinged side is adapted to receive a first lock member on said second hinged side of said hinged bar.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable.

### BACKGROUND OF THE INVENTION

1. Field of the Invention

The present invention relates to trailer accessories for road tractor trucks. More particularly, the present invention relates to a hinged mud flap light-bar that can be secured to the back of a road tractor.

2. Description of Related Prior Art

Light bars of mud flap bars are oftentimes added to a semi-road tractor (or, semi trailer truck, because they often pull semi trailers) because of motor vehicle mud flap requirements. Mud flaps are large rubber mats that extend downward from the bar and prevent rocks and other debris from spraying back onto other vehicles.

However, mud flaps can be quite large and os an extra bar is needed to support the mud flaps. A problem arises however during turning of the tractor when attached to a semi trailer, specifically, the mud flap and even the bar can interfere with the trailer and damage or destroy the flaps, trailer, or bar or, otherwise make turning difficult.

Further, damaged flaps and bars are costly and therefore many road tractors are not outfitted with them because of their breakage rate and the high cost to replace them.

What is needed is an affordable, less damage prone flap bar that can fold or retract to prevent damage, can support mud flaps, and can also allow for lighting and other vehicular requirements to be contained in the flap bar.

### SUMMARY OF THE INVENTION

Accordingly, it is an object of the present invention to provide a hinged light bar comprising a hinged housing portion having a top, bottom, side, and interior, and adapted to receive one or more mud flaps; and the housing portion is removably securable to a tractor or other vehicle.

Further, the hinged light bar housing portion can be adapted to receive one or more lights operatively engaging a tractor or vehicle; one or more lock members on the housing portion to keep the hinged light bar either open or closed; or one or more extruding flanges adapted to receive one or more mud flaps where one or more mud flaps can fold when the hinged light bar is folded.

### BRIEF DESCRIPTION OF THE DRAWINGS

FIG. 1 is an elevated perspective view of a hinged light bar in an extended position.

FIG. 2 is an elevated perspective view of two hinged light bar assemblies in an extended position and secured to the back of a tractor.

FIG. 3 is an elevated perspective view of two hinged light bars secured to a tractor and in a folded position.

FIG. 4 is a detail view of a hinged light bar in a folded position.

### DETAILED DESCRIPTION OF THE DRAWINGS AND PREFERRED EMBODIMENTS

A complete understanding of this invention can be gained through reference to the drawings in conjunction with a thorough review of the disclosure herein.

In general, the present invention is a novel rear light bar 1 for road tractors that folds and can also hold mud flaps 8. A folding light bar 1 prevents it or mud flaps from striking a trailer 11 hitched to a road tractor. Further, the light bar 1 can be folded while still attached to a road tractor without having to take off the entire light bar assembly as is currently done with rigid, non-foldable light bars.

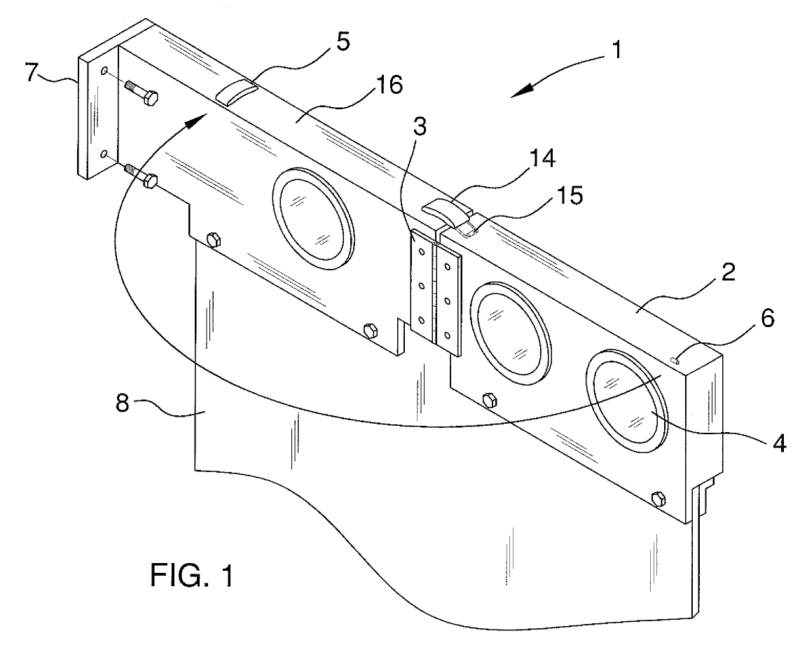

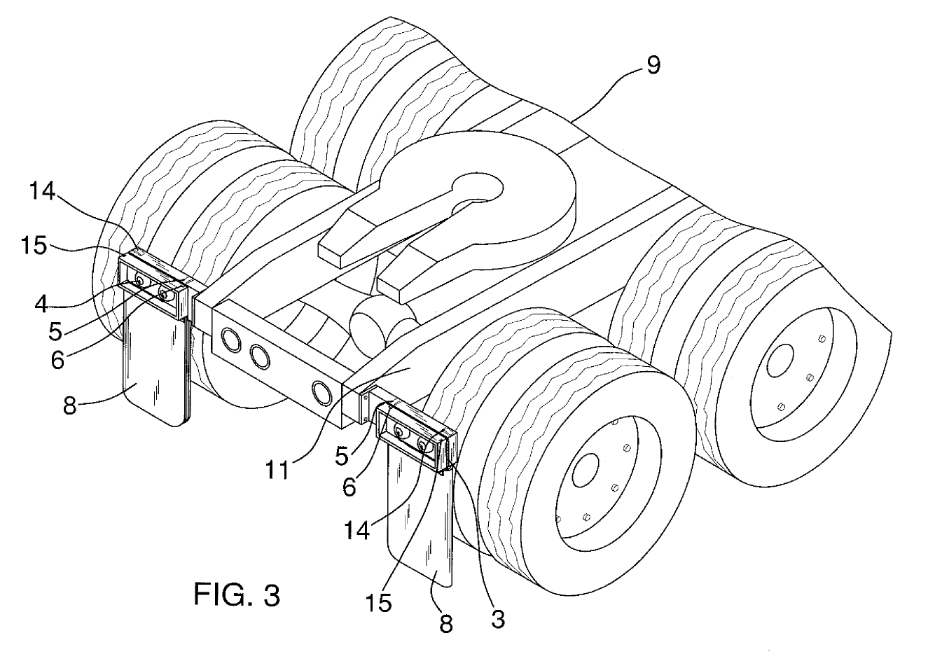

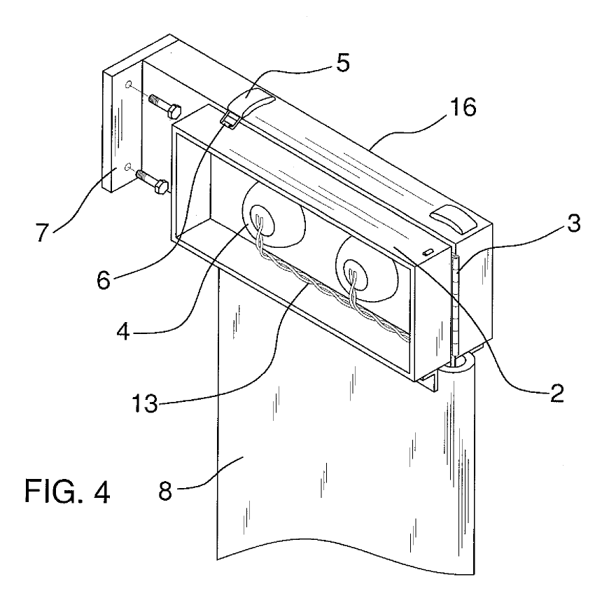

FIG. 1 depicts a hinged light bar 1 in a fully extended position. An end mount 7 is attached through screws, bolts, or other known attachments 6, either fixedly or removably, to secure light bar 1 to the rear of a tractor trailer. Additionally, a first housing part 2 and a second housing part 16 of a light bar 1 housing are locked in an extended position by a locking clasp assembly 14 15 attached to the top of a first housing part 2 and second housing part 16. Further methods are also possible through pins, screws, or other known removable attachment device where the hinged sides meet. The attachment could be in the rear interior, on top, or underneath of housing unit. Similarly, and as is shown in FIGS. 3 and 4, a clasp assembly 5 6 on the top of a light bar 1 can be used to secure a retracted light bar 1.

Preferably the main housing unit of the light bar 1 comprises a recessed backing as is shown in FIGS. 3 and 4 so that lights 4 or other ornamental or necessary display devices can be cut out and attached into the back of light bar 1 while enabling the lights 4 to be visible to rear traffic. Electrical leads 13 or other necessary couplings can be set away from external impact in the event of impact from behind or from environmental forces. In one implementation, recessed rear brake lights 4 are fitted into a rear-projecting position with running lights attached to the side of light bar 1. (not shown)

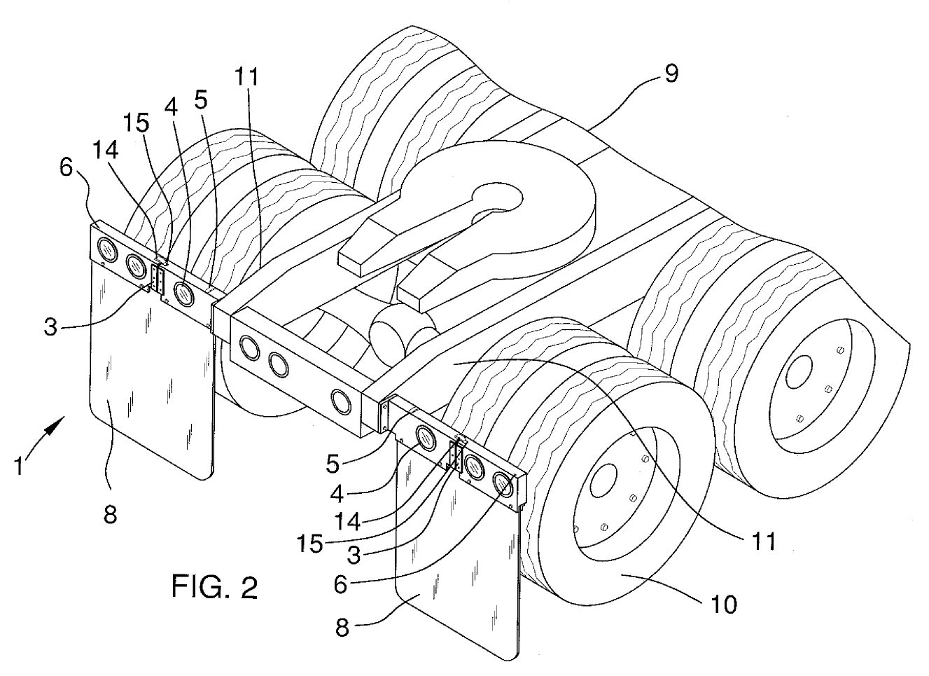

Light bar 1 can be fastened to a tractor 11 in any number of ways so as to not interfere with the rear wheels 10. A preferred embodiment shown here is through a plurality of bolts 6 fastened through a welded or machined flange 7 on the end of a light bar allowing it to be removably secured to a tractor 11 so as to cover the rear wheel discharge without interfering with the wheels 10. However, heavy duty clamps, pins could also be used. In FIGS. 2 3 and 4, a light bar 1 is shown with a flange 7 secured to the frame of a road tractor 11. A flange 7 is positioned internally or otherwise to a light bar so that it is mounted along an interior axis and perpendicular to the rear of a tractor 11. Ultimately, the mounting will depend on the structure and design of each tractor which can vary with each manufacturer.

Alternately, and rather than being mounted via bolts or other similar mounting mechanisms to the side of a tractor frame, the light bar 1 can also be mounted on top of the frame portion that extends along the axis of the tractor.

The Figures depict a single, heavy duty multiple loop hinge 3 that extends the height of the light bar 1 to allow a first part 2 and second part 16 of light bar 1 to be extended and retracted. These types of hinges are preferred because of their greater load bearing capacity however, other known hinges such as butt, barrel, concealed, continuous, flush, or multiple hinges could also be used.

The main hinged, housing portion of light bar 1 measures between 5-10 inches in height, 2-5 inches in depth, and between 2-5 feet long. However, state limitations on tractor attachments will vary and could exceed or fit under these size limitations.

Although several embodiments have been described, the same should not be construed as limited thereby to specific features mentioned herein, but include various other equivalent features and should only be limited in accordance with the claims appended hereto. It is understood that any suitable changes or substitutions may be made without departing from the spirit and scope of the invention.

I claim:

1. A hinged light bar comprising:
a hinged bar having a top, bottom, side and rear, and adapted to receive one or more mud flaps; and
said bar being removably securable to a vehicle.

2. The hinged light bar of claim 1 wherein said bar is adapted to receive one or more lights operatively engaging said vehicle.

3. The hinged light bar of claim 1 further comprising one or more lock members on a top, bottom, side, or rear of said bar for securing said hinged bar in either an extended or folded position.

4. The hinged light bar of claim 1 further comprising one or more flanges extending from said bar and adapted to receive one or more mud flaps.

5. The hinged light bar of claim 1 further comprising:
a first and a second hinged side of said hinged bar; and
said first hinged side is adapted to receive a first lock member on said second hinged side of said hinged bar.
